(19) United States
(12) Patent Application Publication
(10) Pub. No.: US 2024/0240401 A1
(43) Pub. Date: Jul. 18, 2024

(54) PRESSURE DIFFUSER LOWER BEARING

(71) Applicant: ANDRITZ INC., Alpharetta, CA (US)

(72) Inventors: Tyson B. Hunt, Saratoga Springs, NY (US); Grant Bechard, Queensbury, NY (US); Spencer Williams, Troy, NY (US); Keith Vogel, Queensbury, NY (US); Jeff Williams, Lake Luzerne, NY (US)

(73) Assignee: ANDRITZ INC., Alpharetta, GA (US)

(21) Appl. No.: 18/096,789

(22) Filed: Jan. 13, 2023

(51) Int. Cl. D21C 9/04; F16C 29/02

(52) U.S. Cl. CPC D21C 9/04; F16C 29/02; F16C 33/20

(57) ABSTRACT

A bearing for guiding reciprocating vertical movement of a pressure diffuser screen assembly may include: a bearing cylinder; a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder; and a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder. An inner diameter of the bearing cylinder may provide a bearing surface for the bearing assembly.

### BACKGROUND

Unless otherwise indicated herein, the materials described in this section are not prior art to the claims in this application and are not admitted to being prior art by inclusion in this section.

In the papermaking industry, a pressure diffuser is used for washing lignocellulosic pulp by diffusion. A pressure diffuser is typically a vertically arranged tower. The pulp is fed into the bottom of the pressure diffuser under pressure and moves upward through an annular space between a diffuser shell and a concentrically arranged screen assembly. A solvent, for example water, is injected into the annular space to wash the pulp as it moves vertically through the pressure diffuser. Filtrate passing through the pulp flows through the screen assembly and is extracted from the bottom of the pressure diffuser. The washed pulp is extracted from the top of the pressure diffuser.

During extraction of the washing filtrate, the concentrically arranged screen assembly moves vertically upward from a lower position to an upper position at a speed slightly faster than the pulp flow speed. The upward movement encourages the flow of the pulp towards the top of the pressure diffuser. When the screen assembly reaches the upper position, the washing filtrate extraction is interrupted, and the screen assembly is rapidly pulled down to the lower position. The downward movement prevents buildup of pulp fibers on the screen assembly.

The vertical movement of the concentrically arranged screen assembly is guided by upper and lower bearing assemblies near the top and bottom, respectively, of the pressure diffuser. During the downward movement of the screen assembly, the lower bearing assembly is plunged into the pulp entering the diffuser. As the lower bearing assembly is plunged into the pulp, pulp fibers can become lodged in the bearing assembly causing the bearing assembly to wear and allowing pulp fibers to pass and mix with the filtrate extracted from the pressure diffuser. When the amount of fiber in the filtrate exceeds a certain amount, other equipment receiving the filtrate downstream of the pressure diffuser can become plugged with the fibers.

FIG. 1A is diagram illustrating an example of a pressure diffuser 100. The pressure diffuser 100 may include a pressure diffuser screen assembly 105 having a screen assembly support 115 coupled to an actuator 117. The actuator 117 may cause reciprocating vertical motion of the pressure diffuser screen assembly 105 within the shell 120 of the pressure diffuser 100. The pressure diffuser screen assembly 105 may be supported at the upper end 102 of the pressure diffuser 100 by an upper bearing 130 including an upper bearing assembly 135 and upper bearing cylinder 137 and may be supported at the lower end 104 of the pressure diffuser 100 by a lower bearing 140 including a lower bearing assembly 145 and lower bearing cylinder 147.

An annulus 150 may be formed between the pressure diffuser screen assembly 105 and the shell 120 of the pressure diffuser 100. Pulp 155 may be injected into the annulus 150 at the lower end 104 of the pressure diffuser 100. As the actuator 117 causes the reciprocating vertical motion of the pressure diffuser screen assembly 105, the pulp 155 moves vertically through the annulus 150 of the pressure diffuser 100. As the pulp 155 rises vertically through the annulus 150 of the pressure diffuser 100, wash filtrate is injected by wash distribution headers 160. Liquor 170 produced by the washing process flows through the pressure diffuser screen assembly 105 and is extracted from the lower end 104 of the pressure diffuser 100. The washed pulp 157 is extracted from the upper end 102 of the pressure diffuser 100.

FIG. 1B is an expanded view of the lower end 104 of the pressure diffuser 100. Referring to FIG. 1B, the lower bearing assembly 145 may be a relatively soft material, for example, a high-performance plastic material, attached to an inner circumference of the pressure diffuser screen assembly 105. The outer circumference 149 of the bearing cylinder 147 may provide a bearing surface for the lower bearing assembly 145. During the reciprocating vertical motion of the pressure diffuser screen assembly 105, the lower bearing assembly 145 travels vertically along the outer circumference 149 of the stationary bearing cylinder 147. As the pressure diffuser screen assembly 105 is pulled downward during the reciprocating vertical motion, the lower bearing assembly 145 is plunged into the pulp (e.g., the pulp 155 illustrated in FIG. 1A) being fed into the annulus 150 between the pressure diffuser screen assembly 105 and the shell 120 of the pressure diffuser 100. The reciprocating vertical motion repeats approximately every six seconds. The repeated plunging of the lower bearing assembly 145 into the pulp can cause pulp fibers to become lodged between the lower bearing assembly 145 and the outer circumference 149 of the bearing cylinder 147 causing wear of the lower bearing assembly 145 and allowing pulp fibers to mix with the filtrate (e.g., the liquor 170) being extracted from the pressure diffuser 100.

### SUMMARY

Systems and methods for providing a bearing for guiding reciprocating vertical movement of a pressure diffuser screen are provided.

According to various aspects there is provided a bearing for guiding reciprocating vertical movement of a pressure diffuser screen assembly. In some aspects, the bearing may include: a bearing cylinder; a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder; and a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder. An inner diameter of the bearing cylinder may provide a bearing surface for the bearing assembly.

According to various aspects there is provided a pressure diffuser. In some aspects, the pressure diffuser may include: a pressure diffuser shell; a pressure diffuser screen assembly configured for reciprocating vertical movement within the pressure diffuser shell; a bearing cylinder; a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder; and a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder. An inner diameter of the bearing cylinder may provide a bearing surface for the bearing assembly.

According to various aspects there is provided a method for providing a bearing for guiding reciprocating vertical movement of a pressure diffuser screen assembly. In some aspects, the bearing may include: a bearing cylinder; a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder; a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder. An inner diameter of the bearing cylinder may provide a bearing surface for the bearing assembly.

The method may include: removing a lower portion of the pressure diffuser screen assembly to form a shortened pressure diffuser screen assembly; coupling the bearing assembly to the lower portion of the screen extension; positioning the screen extension and the bearing assembly within the inner diameter of the bearing cylinder; and coupling the upper portion of the screen extension to the lower portion of the shortened pressure diffuser screen assembly.

### BRIEF DESCRIPTION OF THE DRAWINGS

Aspects and features of the various embodiments will be more apparent by describing examples with reference to the accompanying drawings, in which:

FIG. 1A is diagram illustrating an example of a pressure diffuser;

FIG. 1B is a diagram illustrating a lower bearing assembly for the pressure diffuser;

FIG. 2A is an expanded view of the lower end of a pressure diffuser illustrating an example of a lower bearing including a lower bearing assembly and lower bearing cylinder according to some aspects of the present disclosure;

FIG. 2B is a diagram illustrating a cutaway view of a pressure diffuser illustrating the pressure diffuser screen according to some aspects of the present disclosure; and

FIG. 3 is a flowchart illustrating an example of a method for providing a lower bearing for guiding reciprocating vertical movement of a pressure diffuser screen according to some aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

Similar reference characters indicate corresponding parts throughout the several views unless otherwise stated. Although the drawings represent embodiments of various features and components according to the present disclosure, the drawings are not necessarily to scale and certain features may be exaggerated in order to better illustrate embodiments of the present disclosure, and such exemplifications are not to be construed as limiting the scope of the present disclosure.

Except as otherwise expressly stated herein, the following rules of interpretation apply to this specification: (a) all words used herein shall be construed to be of such gender or number (singular or plural) as to circumstances require; (b) the singular terms “a,” “an,” and “the,” as used in the specification and the appended claims include plural references unless the context clearly dictates otherwise; (c) the antecedent term “about” applied to a recited range or value denotes an approximation within the deviation in the range or values known or expected in the art from the measurements; (d) the words “herein,” “hereby,” “hereto,” “hereinbefore,” and “hereinafter,” and words of similar import, refer to this specification in its entirety and not to any particular paragraph, claim, or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms, “comprising,” “having,” “including,” and “containing” are to be construed as open-ended terms (i.e., meaning “including but not limited to”).

Recitation of ranges of values herein are merely intended to serve as a shorthand method of referring individually to each separate value falling within the range of within any sub ranges there between, unless otherwise clearly indicated herein. Each separate value within a recited range is incorporated into the specification or claims as if each separate value were individually recited herein. Where a specific range of values is provided, it is understood that each intervening value, to the tenth or less of the unit of the lower limit between the upper and lower limit of that range and any other stated or intervening value in that stated range or sub range hereof, is included herein unless the context clearly dictates otherwise. All subranges are also included. The upper and lower limits of these smaller ranges are also included therein, subject to any specifically and expressly excluded limit in the stated range.

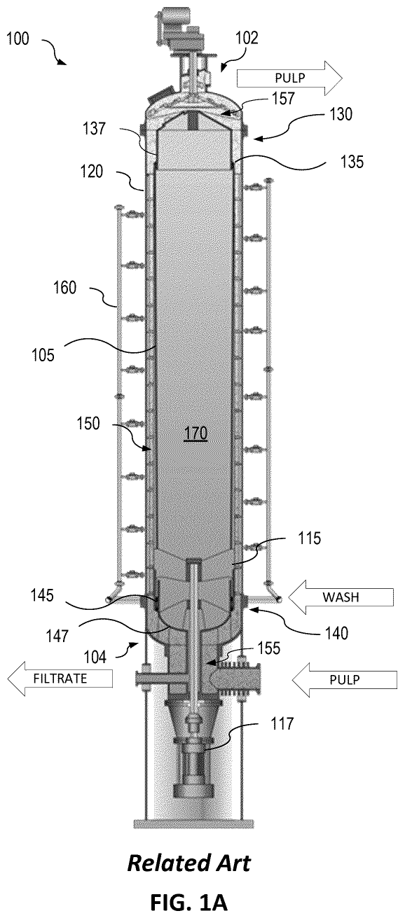

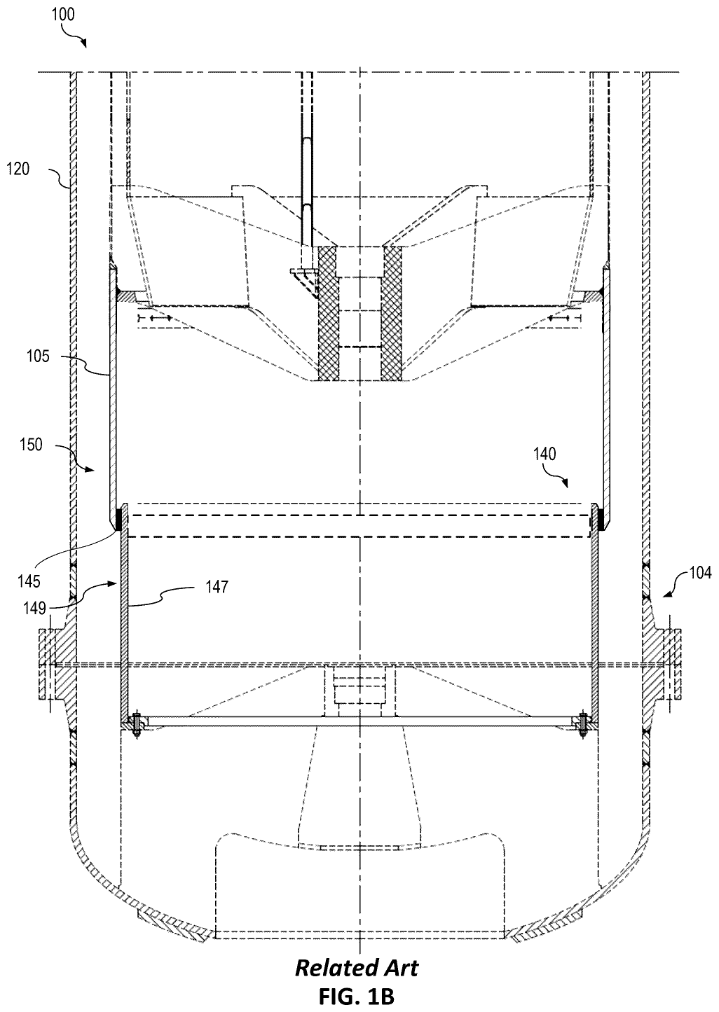

In a conventional pressure diffuser, for example as illustrated in FIGS. 1A and 1B, repeated plunging of the lower bearing assembly into the incoming pulp during constant reciprocating vertical motion of the pressure diffuser screen may cause wear of the lower bearing assembly. As the lower bearing assembly wears, pulp fibers are undesirably mixed with the filtrate extracted from the pressure diffuser and can cause downstream equipment to become plugged with the pulp fibers. Aspects of the present disclosure provide an improved pressure diffuser lower bearing that can reduce wear of the lower bearing assembly. The pressure diffuser lower bearing according to the present disclosure may be suitable for new pressure diffuser builds as well as for retrofits of existing pressure diffusers.

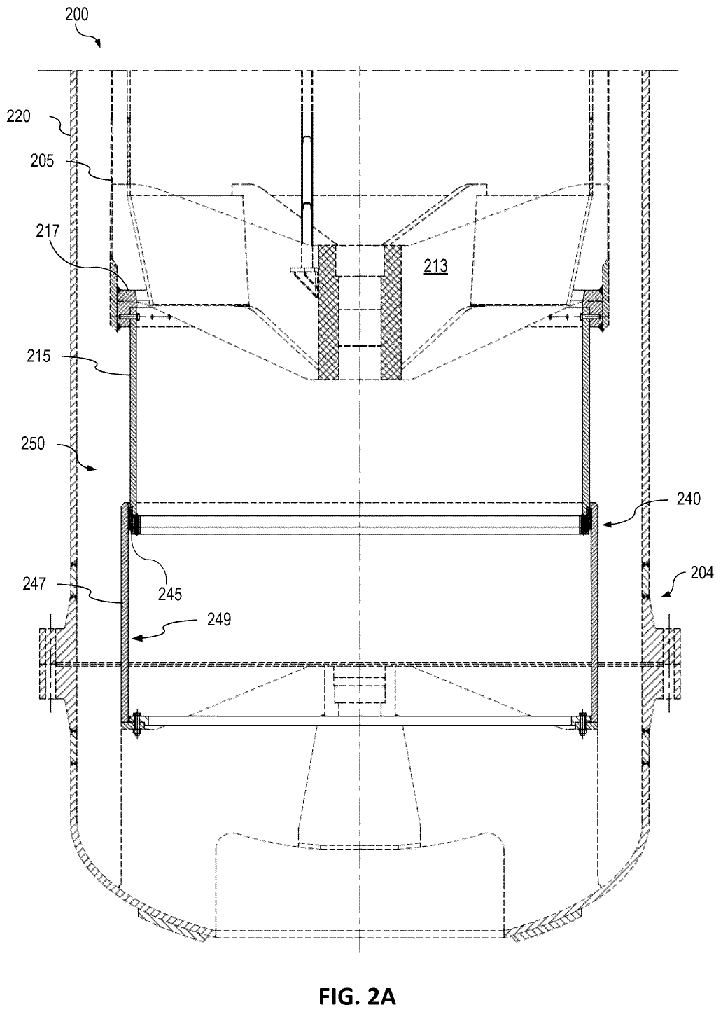

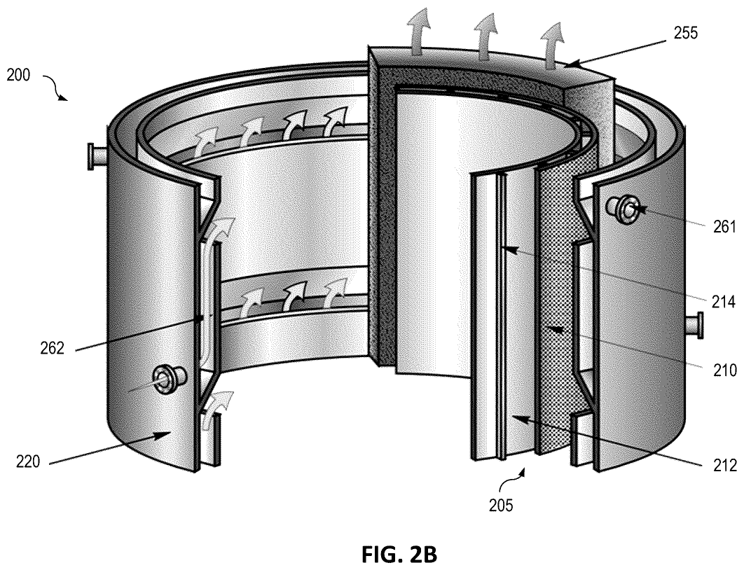

FIG. 2A is an expanded view of the lower end 204 of a pressure diffuser 200 illustrating an example of a lower bearing 240 for a pressure diffuser according to some aspects of the present disclosure. The lower bearing 240 may provide a guiding surface for the vertical reciprocating motion of the pressure diffuser screen assembly 205 as well as provide a seal between the pulp fibers in the annulus 250 of the pressure diffuser 200 and the filtrate in the center portion of the pressure diffuser 200. The lower bearing 240 may include a lower bearing assembly 245 and lower bearing cylinder 247. The lower bearing cylinder may be referred to herein interchangeably as the bearing cylinder or the lower bearing cylinder. The lower bearing assembly 245 may include a relatively soft material, for example, but not limited to, a high-performance plastic material, in comparison to the lower bearing cylinder 247.

FIG. 2B is a diagram illustrating a cutaway view of a pressure diffuser 200 illustrating the pressure diffuser screen assembly 205 according to some aspects of the present disclosure. As shown in FIG. 2B, the pressure diffuser screen assembly 205 may include the pressure diffuser screen 210 mounted on support ribs 214 to a support cylinder 212. Wash nozzles 261 provided on the pressure diffuser shell 220 may introduce wash fluid 262 into the pressure diffuser 200 to wash the pulp 255. The filtrate from the washed pulp 255 may flow through the pressure diffuser screen 210 into channels formed by the support ribs 214 and collect in the support cylinder 212 from where it is extracted from the pressure diffuser.

Referring again to FIG. 2A, according to some aspects of the present disclosure, the cylindrical pressure diffuser screen assembly 205 of the pressure diffuser 200 may have a length shorter than a conventional pressure diffuser screen assembly (see, for example, the pressure diffuser screen assembly 105 in FIG. 1B). The pressure diffuser screen assembly 205 may be fabricated in cylindrical sections to form a pressure diffuser screen assembly having a specified length. According to aspects of the present disclosure, the length of the pressure diffuser screen assembly 205 below the screen assembly support 213 may be reduced compared to a conventional pressure diffuser screen assembly by removing a cylindrical section of the pressure diffuser screen assembly. For example, the length may be reduced by 24-30 inches, or another amount determined based on the vertical stroke of the pressure diffuser screen 210 during its vertical reciprocating motion. For new build pressure diffuser applications, the pressure diffuser screen may be fabricated with the shortened portion below the screen assembly support. For retrofit applications, the required portion of the existing pressure diffuser screen below the screen assembly support may be removed.

A cylindrical screen extension 215 having a substantially same configuration as the pressure diffuser screen 210 may be provided to extend the pressure diffuser screen assembly 205. The screen extension 215 may have an outer diameter less than the inner diameter of the pressure diffuser screen assembly 205 and may include a support cylinder having support ribs (not shown) and a pressure diffuser screen (not shown) mounted on the support ribs similar to the pressure diffuser screen assembly 205. The screen extension 215 may be coupled to a bottom portion of the pressure diffuser screen assembly 205 below the screen assembly support 213.

The screen extension 215 diameter may be dimensioned such that the lower bearing assembly 245 mounted to the outer circumference of the screen extension 215 fits within the inner circumference of the existing bearing cylinder 247. The lower bearing assembly 245 may have an inner diameter corresponding to an outer diameter of the screen extension 215 and an outer diameter corresponding to an inner diameter of the existing bearing cylinder 247. The screen extension 215 may have sufficient length for example, 24-30 inches or another length, to enable the lower bearing assembly 245 to remain within the bearing cylinder 247 and in contact with the bearing surface on the inner surface 249 of the bearing cylinder 247 during the vertical reciprocating motion of the pressure diffuser screen assembly 205. In some implementations, the lower bearing assembly 245 may be coupled to the inner surface 249 of the bearing cylinder 247 and the screen extension 215 may provide the bearing surface. In such an implementation, the lower bearing assembly 245 may remain stationary as the screen extension 215 undergoes the vertical reciprocating motion.

Thus, for the lower bearing 240 of the present disclosure, the inner surface 249 of the bearing cylinder 247 provides the bearing surface for the lower bearing assembly 245 rather than the outer surface of the bearing cylinder as in a conventional pressure diffuser (see, e.g., FIG. 1B). The inner surface 249 of the bearing cylinder 247 may have a suitable surface finish to provide a bearing surface for the bearing assembly 245. In some implementations, machining operations for example, but not limited to, grinding operations, may be performed on the inner surface 249 of the bearing cylinder 247 to provide the surface finish suitable for a bearing surface for the bearing assembly 245.

The screen extension 215 may be coupled to the pressure diffuser screen assembly 205 in a manner to provide the appropriate relationship between the lower bearing assembly 245 and the inner surface 249 of the bearing cylinder 247 such that the lower bearing assembly 245 can provide a seal against the inner surface 249 of the bearing cylinder 247 at an operating temperature of the pressure diffuser. For example, an adapter ring 217 may be provided to couple the screen extension 215 to the pressure diffuser screen assembly 205. The adapter ring 217 may have an outer diameter corresponding to an inner diameter of the pressure diffuser screen 210 and an inner diameter corresponding to an outer diameter of the screen extension 215. A thickness of the adapter ring 217 between its inner and outer diameter may be determined to provide the positional relationship between the lower bearing assembly 245 and the bearing surface on the inner surface 249 of the bearing cylinder 247. Other methods of attaching the screen extension 215 to the pressure diffuser screen assembly 205 may be provided without departing from the scope of the present disclosure.

The shorter pressure diffuser screen assembly 205 combined with the smaller diameter screen extension 215 can enable the lower bearing assembly 245 to contact an inner surface 249 on an inner circumference of the bearing cylinder 247 as a bearing surface. Providing the bearing surface on the inner circumference of the bearing cylinder 247 reduces contact of the lower bearing assembly 245 with the incoming pulp.

During the downstroke of the reciprocating vertical motion of the pressure diffuser screen assembly 205, the lower bearing assembly 245 of the present disclosure is plunged into the filtrate contained within the bearing cylinder 247 rather than into the pulp as in conventional pressure diffusers, thereby minimizing the intrusion of pulp fibers into the lower bearing assembly 245 and reducing the amount of fibers mixing with the filtrate extracted from the pressure diffuser 200.

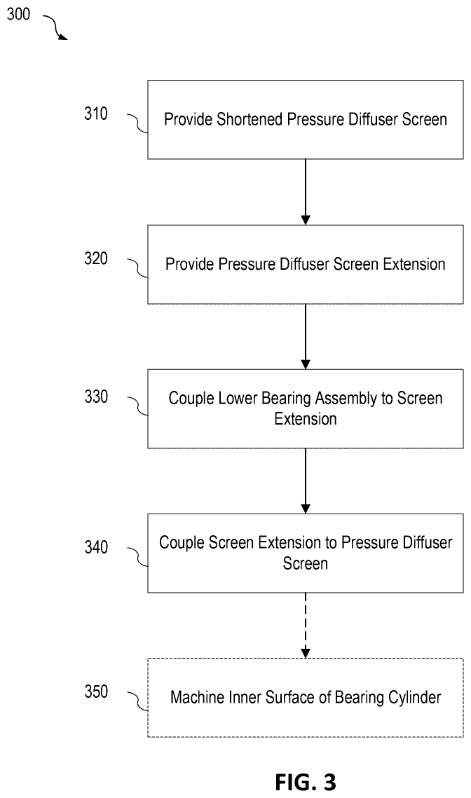

FIG. 3 is a flowchart illustrating an example of a method 300 for providing a lower bearing for guiding reciprocating vertical movement of a pressure diffuser screen according to some aspects of the present disclosure. Referring to FIG. 3, at block 310, a shortened pressure diffuser screen assembly may be provided for the pressure diffuser. For a retrofit of an existing pressure diffuser, a portion of the pressure diffuser screen assembly, for example 24-30 inches of the existing diffuser screen assembly, may be removed below the screen assembly support. For a new build pressure diffuser, the shortened pressure diffuser screen assembly of the appropriate length may be fabricated.

At block 320, a screen extension may be provided for the pressure diffuser. The screen extension may have a substantially same configuration as the pressure diffuser screen assembly. The screen extension may have an outer diameter less than the inner diameter of the pressure diffuser screen assembly and may extend the pressure diffuser screen to enable the lower bearing assembly to remain within the bearing cylinder and in contact with the bearing surface during the vertical reciprocating motion of the pressure diffuser screen assembly.

At block 330, a lower bearing assembly may be coupled to the screen extension. The lower bearing assembly may have an inner diameter corresponding to an outer diameter of the screen extension and an outer diameter corresponding to an inner diameter of the existing bearing cylinder. The screen extension diameter may be dimensioned such that the bearing assembly mounted to the outer circumference of the screen extension fits within the inner circumference of the existing bearing cylinder. In some implementations, the lower bearing assembly may be coupled to the internal surface of the bearing cylinder and the screen extension may provide the bearing surface. In such an implementation, the lower bearing assembly may remain stationary as the screen extension undergoes the vertical reciprocating motion.

At block 340, the screen extension may be coupled to the pressure diffuser screen assembly. The screen extension may be coupled to a bottom portion of the pressure diffuser screen assembly below the screen assembly support in a manner to provide the appropriate relationship between the lower bearing assembly and the inner surface of the bearing cylinder. In one implementation, an adapter ring may be provided to couple the screen extension to the pressure diffuser screen assembly. The adapter ring may have an outer diameter corresponding to an inner diameter of the pressure diffuser screen assembly and an inner diameter corresponding to an outer diameter of the screen extension. A thickness of the adapter ring between its inner and outer diameter may be determined to provide the positional relationship between the lower bearing assembly and the bearing surface on the inner surface of the bearing cylinder. Other methods of attaching the screen extension to the pressure diffuser screen assembly may be provided without departing from the scope of the present disclosure.

In one implementation according to the present disclosure, the inner surface of the bearing cylinder rather than the outer surface of the bearing cylinder provides the bearing surface for the lower bearing assembly. Accordingly, the lower bearing assembly is plunged into the filtrate contained within the bearing cylinder rather than into the pulp as in conventional pressure diffusers, thereby minimizing the intrusion of pulp fibers into the lower bearing assembly and reducing the amount of fibers mixing with the filtrate extracted from the pressure diffuser.

In another implementation according to the present disclosure, the lower bearing assembly is coupled to the inner surface of the bearing cylinder and the bearing surface is provided by the screen extension. Accordingly, the lower bearing assembly remain stationary while the screen extension is plunged into the filtrate contained within the bearing cylinder.

At optional block 350, the inner surface of the bearing cylinder may be machined. Machining operations, for example, but not limited to grinding, may be performed on the inner surface of the bearing cylinder may be machined to provide a suitable surface finish to provide a bearing surface for the bearing assembly.

The specific operations illustrated in FIG. 3 provide a particular method for providing a bearing for guiding vertical movement of a pressure diffuser screen according to an implementation of the present disclosure. Other sequences of operations may also be performed according to alternative implementations. For example, alternative implementations of the present disclosure may perform the operations outlined above in a different order. Moreover, the individual operations illustrated in FIG. 3 may include multiple sub-operations that may be performed in various sequences as appropriate to the individual operation. Furthermore, additional operations may be added or removed depending on the particular applications.

The examples and embodiments described herein are for illustrative purposes only. Various modifications or changes in light thereof will be apparent to persons skilled in the art. These are to be included within the spirit and purview of this application, and the scope of the appended claims, which follow.

What is claimed is:

1. A bearing for guiding reciprocating vertical movement of a pressure diffuser screen assembly, the bearing comprising:
a bearing cylinder;
a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder; and
a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder,
wherein an inner diameter of the bearing cylinder comprises a bearing surface for the bearing assembly.

2. The bearing of claim 1, wherein the screen extension comprises a support cylinder having support ribs, and a pressure diffuser screen mounted on the support ribs.

3. The bearing of claim 1, further comprising an adapter ring configured to couple the upper portion of the screen extension to the lower portion of the pressure diffuser screen assembly,
wherein the adapter ring has an adapter ring outer diameter corresponding to a pressure diffuser screen assembly inner diameter and an adapter ring inner diameter corresponding to the screen extension outer diameter.

4. The bearing of claim 1, wherein the bearing assembly comprises an annular bearing disposed around an outer circumference of the screen extension.

5. The bearing of claim 4, wherein the annular bearing comprises a material softer than the material comprising the bearing cylinder.

6. The bearing of claim 4, wherein the annular bearing comprises a high-performance plastic material.

7. A pressure diffuser, comprising:
a pressure diffuser shell;
a pressure diffuser screen assembly configured for reciprocating vertical movement within the pressure diffuser shell;
a bearing cylinder;
a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder; and
a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder,
wherein an inner diameter of the bearing cylinder comprises a bearing surface for the bearing assembly.

8. The pressure diffuser of claim 7, wherein the screen extension comprises a support cylinder having support ribs, and a pressure diffuser screen mounted on the support ribs.

9. The pressure diffuser of claim 7, further comprising:
an adapter ring configured to couple the upper portion of the screen extension to the lower portion of the pressure diffuser screen assembly,
wherein the adapter ring has an adapter ring outer diameter corresponding to a pressure diffuser screen assembly inner diameter and an adapter ring inner diameter corresponding to the screen extension outer diameter.

10. The pressure diffuser of claim 7, wherein the bearing assembly comprises an annular bearing disposed around a circumference of the screen extension.

11. The pressure diffuser of claim 10, wherein the annular bearing comprises a material softer than the material comprising the bearing cylinder.

12. The pressure diffuser of claim 10, wherein the annular bearing comprises a high-performance plastic material.

13. A method for providing a bearing for guiding reciprocating vertical movement of a pressure diffuser screen assembly, wherein the bearing comprises:
a bearing cylinder;
a screen extension having an upper portion configured to couple to a lower portion of the pressure diffuser screen assembly, the screen extension having a screen extension outer diameter less than a pressure diffuser screen assembly outer diameter and less than an inner diameter of the bearing cylinder;
a bearing assembly configured to couple to the screen extension at a lower portion of the screen extension, the bearing assembly having a bearing assembly inner diameter corresponding to the screen extension outer diameter and a bearing assembly outer diameter corresponding to the inner diameter of the bearing cylinder,
wherein an inner diameter of the bearing cylinder comprises a bearing surface for the bearing assembly,
the method comprising:
removing a lower portion of the pressure diffuser screen assembly to form a shortened pressure diffuser screen assembly;
coupling the bearing assembly to the lower portion of the screen extension;
positioning the screen extension and the bearing assembly within the inner diameter of the bearing cylinder; and
coupling the upper portion of the screen extension to the lower portion of the shortened pressure diffuser screen assembly.

14. The method of claim 13, wherein the screen extension comprises a support cylinder having support ribs, and a pressure diffuser screen mounted on the support ribs.

15. The method of claim 13, wherein coupling the upper portion of the screen extension to the lower portion of the shortened pressure diffuser screen assembly comprises:
coupling an inner diameter of an adapter ring to an outer diameter of the screen extension; and
coupling an outer diameter of the adapter ring to an inner diameter of the shortened pressure diffuser screen assembly.

16. The method of claim 15, wherein the adapter ring has an adapter ring outer diameter corresponding to a pressure diffuser screen assembly inner diameter and an adapter ring inner diameter corresponding to the screen extension outer diameter.

17. The method of claim 13, wherein coupling the bearing assembly to the lower portion of the screen extension comprises coupling an inner diameter of the bearing assembly to an outer diameter of the screen extension.

18. The method of claim 13, wherein the bearing assembly comprises an annular bearing including a material softer than the material comprising the bearing cylinder.

19. The method of claim 18, wherein the annular bearing comprises a high-performance plastic material.

20. The method of claim 13, further comprising performing machining operations on a surface of the inner diameter of the bearing cylinder to provide a bearing surface for the bearing assembly.
